(19) United States
(12) Patent Application Publication
(10) Pub. No.: US 2002/0159619 A1
(43) Pub. Date: Oct. 31, 2002

(54) System for automatically detecting eye corneal striae using reflected lines of light

(75) Inventors: Brian M. Callies, Cordova, TN (US); Roy E. Williams, Collierville, TN (US); James F. Freeman, Memphis, TN (US)

Correspondence Address: David P. Gordon, Esq., 65 Woods End Road, Stamford, CT, 06905, US

(73) Assignee: Memphis Eye & Cataract Associates Ambulatory Surgery Center (dba MECA Laser & Surgery Center)

(21) Appl. No.: 10/008,883

(22) Filed: Nov. 8, 2001

Related U.S. Application Data
(63) Continuation-in-part of application No. 09/842,539, filed on Apr. 26, 2001.

(51) Int. Cl. G06K 9/00

(52) U.S. Cl. 382/128

(57) ABSTRACT

An automated eye corneal striae detection system for use with a refractive laser system includes a cornea illuminator, a video camera interface, a computer, and a video display for showing possible eye corneal striae to the surgeon. The computer includes an interface to control the corneal illuminator, a video frame grabber that extracts images of the eye cornea from the video camera, and is programmed to detect and recognize eye corneal striae. The striae detection algorithm finds possible cornea striae, determines their location, or position, on the cornea and analyzes their shape. After all possible eye corneal striae are detected and analyzed, they are displayed for the surgeon on an external video display. The surgeon can then make a determination as to whether the corneal LASIK flap should be refloated, adjusted or smoothed again.

This application is a continuation-in-part of U.S. Ser. No. 09/842,539 filed Apr. 26, 2001, which is hereby incorporated by reference herein in its entirety.

The U.S. Government has a paid-up, non-exclusive license in this invention as provided for by Grant No. 1R43 EY13349-01 awarded by the National Eye Institute of the National Institutes of Health.

### BACKGROUND

1. Field of the Invention

The present invention relates to ophthalmic surgical procedures for the correction of refractive error. More particularly, the present invention relates to an ophthalmic refractive correction procedure known as LASIK, wherein a corneal flap is produced. Still more particularly, the present invention relates to an ophthalmic instrument and method, which automates the detection of eye corneal striae, or corneal wrinkles, following the LASIK procedure.

2. State of the Art

Laser refractive surgery has become a very popular method for providing patients with better vision. The majority of laser refractive surgery patients will have the procedure termed LASIK (Laser In-Situ Keratomileusis) performed. There are some very important advantages that have caused LASIK to be used over the original Photo-Refractive Keratectomy (PRK) technique. For example, the healing process is usually shorter and more comfortable for the patient and larger refractive corrections can be performed.

In the LASIK procedure a microkeratome device is used to create a thin “flap”, typically 120 to 160-microns in depth and typically 7 to 11-millimeters in diameter, in order to expose the corneal stroma below. The flap is not cut completely across the cornea, thus leaving a hinge. The flap is gently lifted off the cornea and held to the side while the laser system delivers the treatment profile into the cornea stroma (tissue directly underneath the flap). After the laser delivery is completed, the flap is put back in place and smoothed by the surgeon. Within about 2 minutes, the flap is reattached enough such that the lid speculum, which is used to hold the eye open, may be removed, thus allowing the patient to blink. At this point the laser refractive procedure is completed.

Although this procedure does possess many advantages over PRK, it has one drawback that can cause postoperative refractive problems for the patient. The drawback is termed corneal flap striae, which is basically a wrinkle in the corneal flap, created when the flap is not uniformly reattached to the cornea. This striae, or wrinkle, can cause vision problems in the patient ranging from glare to acuity problems due to irregular astigmatism.

Presently, there are two approaches to reducing or eliminating eye corneal striae. The first approach is a preventative method. Here, in one technique, methods and tools have been developed to visibly mark the cornea before the LASIK flap is made. These markings are then used to realign the flap when it is put back in place. U.S. Pat. Nos. 5,934,285 (1999) and 5,697,945 (1997) both to Kritzinger, et. al. describe tools that provide various visible markings to aid in realignment. However, even this technique does not guarantee that there will be no striae present nor does it automate the detection of striae. In another technique described in U.S. Pat. No. 6,019,754 to Kawesch, filtered compressed air is applied to the corneal flap to improve flap adherence. Again, it only addresses flap adherence; it does not address the detection of eye corneal striae.

The second current approach attempts to detect striae after the flap has been put back in place. Currently, there are two dominant methods for attempting to detect striae after the LASIK procedure. Both methods are manual, as opposed to automated, techniques performed by the surgeon. In the most popular method, the refractive surgeon checks the “smoothness” of the cornea, with just the operating microscope and the diffuse, broadband, white light source present with the operating surgical microscope. Here, the surgeon is just making a broad visual determination if striae are present. In a second less popular, but more effective method, the surgeon uses a handheld slit lamp, which projects a thin line of visible broadband, white light onto the cornea. The surgeon scans this line across the cornea and looks for aberrations, or edges, on what otherwise should be a smooth surface. Usually, only two to three scans are made at different angles on the cornea and thus striae can be, and often are, missed at the other angles that are not addressed.

Neither of these two present approaches for reducing or eliminating eye corneal striae addresses the automatic detection of eye corneal striae following LASIK refractive surgery.

Outside the ophthalmic field, U.S. Pat. No. 5,764,345 to Fladd, et al., presents a method for detecting inhomogeneities, specifically striae, in infused silica glasses. This technique was developed for cases where a sample, such as a glass optical lens, can have a beam of light passed through it such that an instrument on the other side of the lens can detect it. This detector is part of an expensive interferometer system used to measure the striae present in the glass. This approach would not work for eye corneal striae detection, as one cannot place a detector on the other side of the cornea. Additionally, the interferometer requires precise alignment and would be too expensive for this application.

Thus, there is no present method for automatically detecting eye corneal striae following LASIK refractive surgery.

### SUMMARY OF THE INVENTION

It is therefore an object of the invention to provide an automated technique for detecting eye corneal striae after LASIK refractive surgery, which is more precise and more complete than existing manual techniques.

It is another object of the invention to provide an automated technique for detecting eye corneal striae after LASIK refractive surgery, which is faster than existing manual techniques.

It is a further object of the invention to provide an automated technique for detecting eye corneal striae after LASIK refractive surgery which will aid in the reduction of patient revisits to correct eye corneal striae problems.

It is an additional object of the invention to provide an automated technique for detecting eye corneal striae after LASIK refractive surgery, which is capable of being retrofit to existing refractive laser systems without modifying any hardware in the existing laser system.

In accord with these objects an automated eye corneal striae detection system is provided for use with a refractive laser system, which produces a laser for surgically reshaping the eye. The automated eye corneal striae detection system includes a means for illuminating the cornea of the eye with a set of lines (a corneal illuminator), a means for moving a patient relative to the set of illumination lines, a means for capturing images of the eye, a computer, and a video display to present possible corneal striae to the surgeon.

The corneal illuminator preferably includes an apparatus for projecting multiple lines of light at predetermined locations comprising a ring shaped housing with a plurality of circularly shaped openings. Within the housing at each circular opening is a plurality of holders for light sources for beams of light, preferably those light wavelengths that are reflected by the cornea, directed out of the circular openings.

The means for moving the patient is preferably a surgical bed, surgical chair or headrest, which is motorized to move the patient, and consequently the patient's cornea, relative to the projected illumination lines. Alternatively, the illumination lines may be moved relative to the cornea of the patient.

The computer preferably includes an opto-isolated, digital input-output printed circuit board, which controls the illuminating apparatus although any digital input-output printed circuit board will suffice; and a video frame grabber, which captures images from a camera on the laser system. The computer is programmed to perform an automated eye corneal striae detection algorithm with respect to the images. The automated eye corneal striae detection algorithm finds possible striae in the images and calculates their position and shape characteristics. The possible striae are then displayed on the video display so that the surgeon can make a determination as to whether the corneal flap should be refloated, adjusted or smoothed again.

The present invention overcomes many of the problems associated with existing manual methods and tools used to prevent and detect eye corneal striae, or corneal wrinkles, after LASIK refractive surgery, by automating the eye corneal striae detection process with a computer-based analysis system.

The automated eye corneal striae detection system may be retrofit to existing refractive laser systems. Additionally, the automated eye corneal striae detection system may be provided as an integral part of new refractive laser surgery systems. If the corneal illuminator is provided as part of a new surgery system, it can also replace the ring illuminator used for visual lighting by providing the same functionality as the ring illuminator.

Additional objects and advantages of the invention will become apparent to those skilled in the art upon reference to the detailed description taken in conjunction with the accompanying drawings.

### BRIEF DESCRIPTION OF THE DRAWINGS

FIG. 1 is a schematic view of a refractive surgery system microscope provided with a corneal illuminator, an automated eye corneal striae detection computer system, a patient positioning interface, and a surgeon's video display according to the invention;

FIG. 2A is a perspective view of a corneal illuminator according to the invention shown attached to a refractive surgery system microscope disposed above an eye being analyzed;

FIG. 2B is a schematic elevation view showing the corneal illuminator juxtaposed with a microsurgery microscope and the surface of the eye and additionally showing a cross section of the linear light beams directed to the cornea;

FIG. 2C is a schematic, upwardly-directed, view taken on line 2C-2C in FIG. 2B and showing the circular openings as well as alternate positions of the openings shown by dashed circles;

FIG. 2D shows a printed circuit board with illumination light sources installed and interface cable connector port along with dashed circles describing alternate positions for the illumination light sources;

FIG. 3A is a schematic view of the corneal illuminator electronics interface subsystem according to the invention;

FIG. 3B is a schematic view of the patient positioning electronics interface subsystem of the invention;

FIG. 4A and 4B comprise a flow chart describing the method of corneal striae detection according to the invention;

FIG. 5 shows all lines illuminated on the cornea at one static position (e.g., not being scanned) during the analysis portion of the invention;

FIG. 6 shows the processed, detected inner and outer edges of all static illuminated lines on the cornea within a region-of-interest shown in FIG. 5, as seen through a camera coupled to a microscope; i.e., inverted from FIG. 5;

FIG. 7A describes the scanning of an illumination line across a cornea within a region-of-interest during the analysis according to the invention, in an inverted orientation relative to FIG. 5;

FIG. 7B shows the processed, detected inner and outer edges of the illumination line described in FIG. 7A, along with the detection of one possible striae object;

FIG. 7C shows one possible detected striae object after all processing has been completed on the scanned positions of the illumination line described in FIG. 7A;

FIG. 8 is an alternate video camera position and attachment method along with a cross section of the linear light beams directed to the cornea;

FIGS. 9A and 9B describe an alternate striae recognition algorithm according to the invention;

FIG. 10 shows a schematic view of an alternative corneal illuminator electronics interface subsystem using fiber optic illumination; and

FIG. 11 shows a digitally captured image of an eye with possible striae highlighted.

### REFERENCE NUMERALS IN DRAWINGS

20 refractive surgery system operating microscope

21 annularly arranged circular openings

22 ring illuminator housing

23 line generator optic

24 illumination light sources

25 corneal illuminator interface cable

26 light emitter

28 cornea

29 eye

31 iris

32 illumination scan line one

33 illumination scan line two

34 illumination scan line three

35 illumination scan line four

36 illumination scan line five

39 illumination scan line six

40 microscope optics

41 pupil

42 video camera optical port

43 cross sectional view of an illumination scan line on the cornea

44 video camera

45 illumination scan line seven

46 automated eye corneal striae detection computer system

47 illumination scan line eight

48 opto-isolated corneal illuminator and patient positioning PC interface board

49 other possible locations for illumination sources

50 video camera interface

51 side view of an illumination scan line on the cornea

52 frame grabber

53 other possible locations for annularly arranged openings

54 eye corneal striae recognition processor

56 video display interface

57 surgical chair (or bed or headrest)

58 corneal illuminator electronics and patient positioning interface subsystem

60 corneal illuminator

62 surgeon's video display

70 interface cable

74 electrical current limiting resistors

80 Automated Eye Corneal Striae Detection Algorithm

82 Turn ON LEDs

84 Send ON Signal to Control Electronics

86 Receive Digitized Image

88 mask out striae area in image

90 apply nonlinear edge detection operator

92 apply thresholding technique

94 apply outer gradient operator

96 apply particle filter

98 get particle parameters from particle filter

99 create ideal lines from particle filter results and subtract from processed outer and inner edges

100 all line scans processed (decision activity)

102 outline possible corneal striae

104 show possible corneal striae on display

106 process for striae again (decision activity)

108 detection algorithm done

120 illumination light source printed circuit board

122 illuminator interface connector port

124 clearance space

126 mounting fasteners

128 ring illuminator housing mounting bracket

134 large clearance hole (in PCB)

136 region-of-interest (ROI)

138 eye optical axis

140 mounting bracket

142 video camera lens

144 alternative fiber optic corneal illuminator and patient positioning electronics interface subsystem

146 fiber optic corneal illuminator interface bundle

148 fiber optic illumination light sources

150 video camera cable

152 video display cable

160 pattern matching technique

162 get matched particle parameters

166 outer edge of illumination scan line one

167 inner edge of illumination scan line one

168 outer edge of illumination scan line two

169 inner edge of illumination scan line two

170 outer edge of illumination scan line three

171 inner edge of illumination scan line three

172 outer edge of illumination scan line four

173 inner edge of illumination scan line four

174 outer edge of illumination scan line five

175 inner edge of illumination scan line five

176 outer edge of illumination scan line six

177 inner edge of illumination scan line six

178 outer edge of illumination scan line seven

179 inner edge of illumination scan line seven

180 outer edge of illumination scan line eight

181 inner edge of illumination scan line eight

183 possible detected striae object

185 steering diode

187 double-pole, double-throw (DPDT) relay, X

188 double-pole, double-throw (DPDT) relay, Y

189 voltage supply for X-left motion, V_{XL}

191 voltage supply for X-right motion, V_{XR}

193 voltage supply for Y-forward motion, V_{YF}

195 voltage supply for Y-back motion, V_{YB}

197 surgical bed interface cable

199 position surgical chair

200 save possible detected striae objects for later display

202 all line positions recorded (decision activity)

204 example of display of possible striae highlighted

206 all scan positions of line processed (decision activity)

### DETAILED DESCRIPTION OF THE PREFERRED EMBODIMENTS

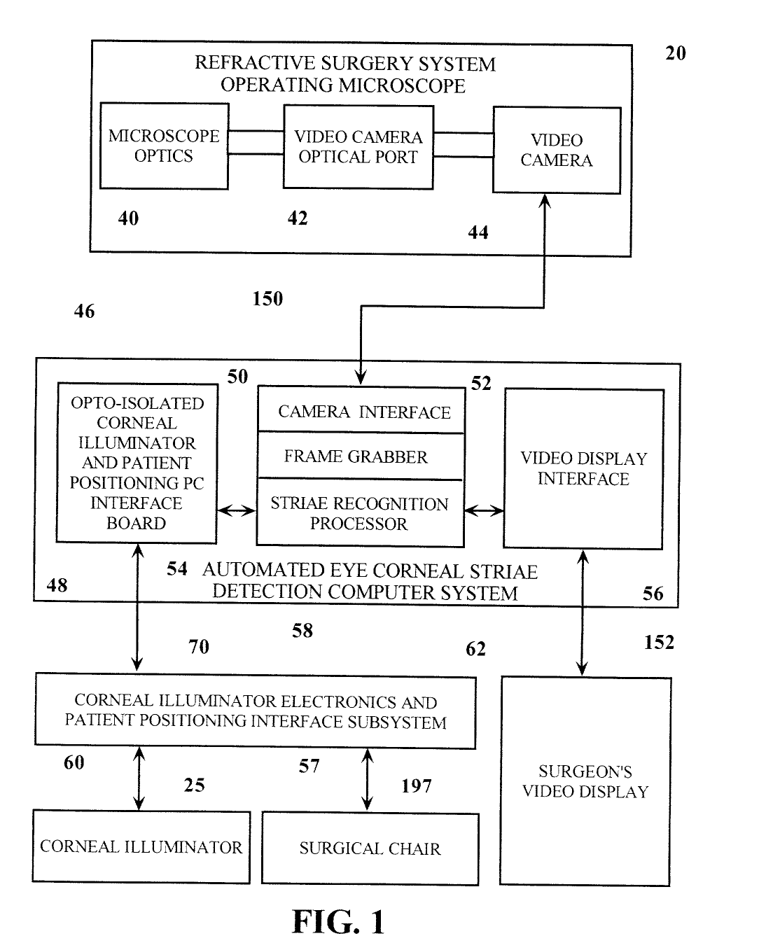

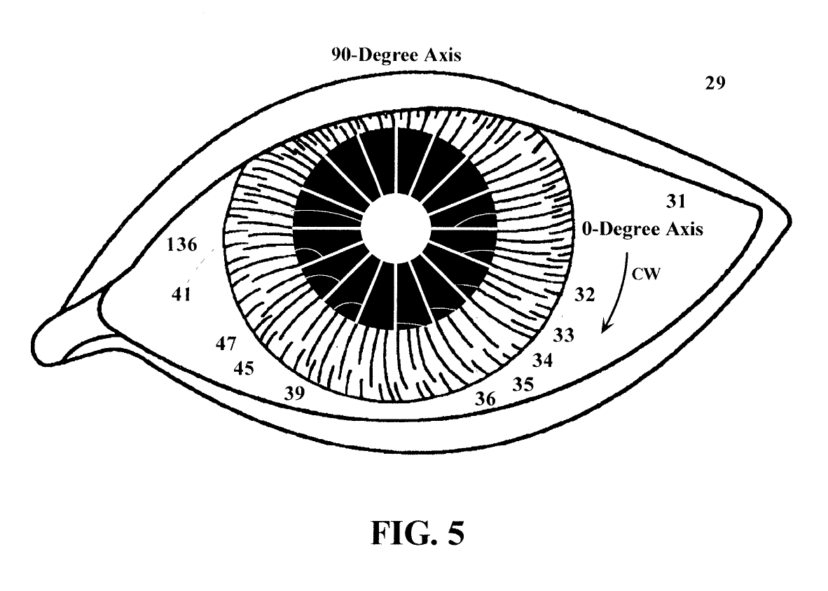

Turning now to FIG. 1, a refractive surgery system operating microscope 20 is coupled to an automated eye corneal striae detection computer system 46 of the invention. The refractive surgery system operating microscope 20 includes a set of microscope optics 40 allowing the surgeon adequate view of the corneal surface and a video camera optical port 42 optically coupling the image the surgeon views to a video camera 44, e.g., a Teli CS6460, that is used to capture a corneal image (FIG. 5).

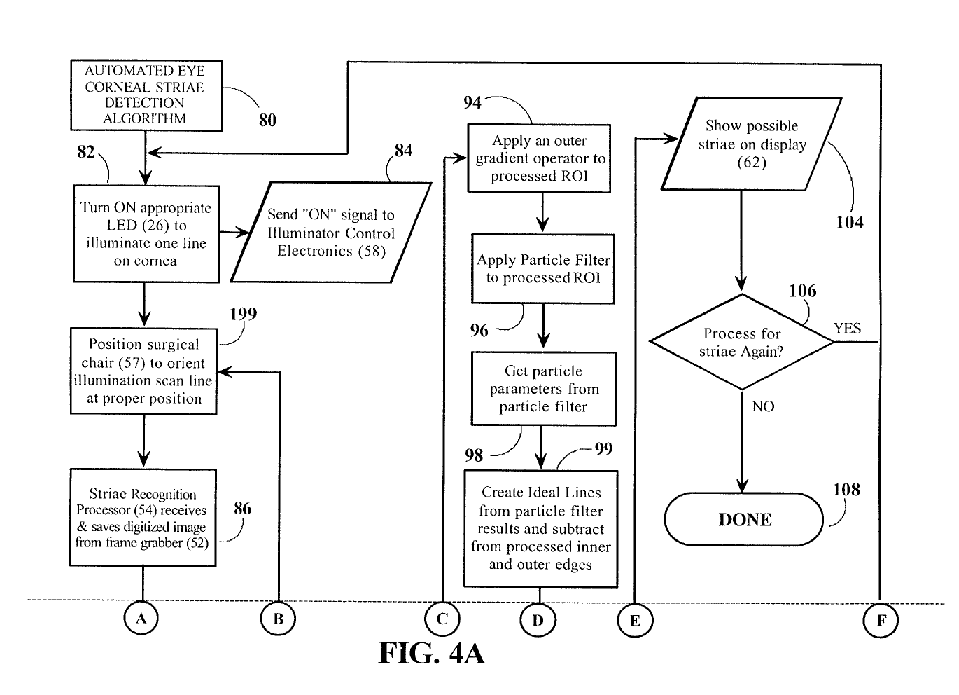

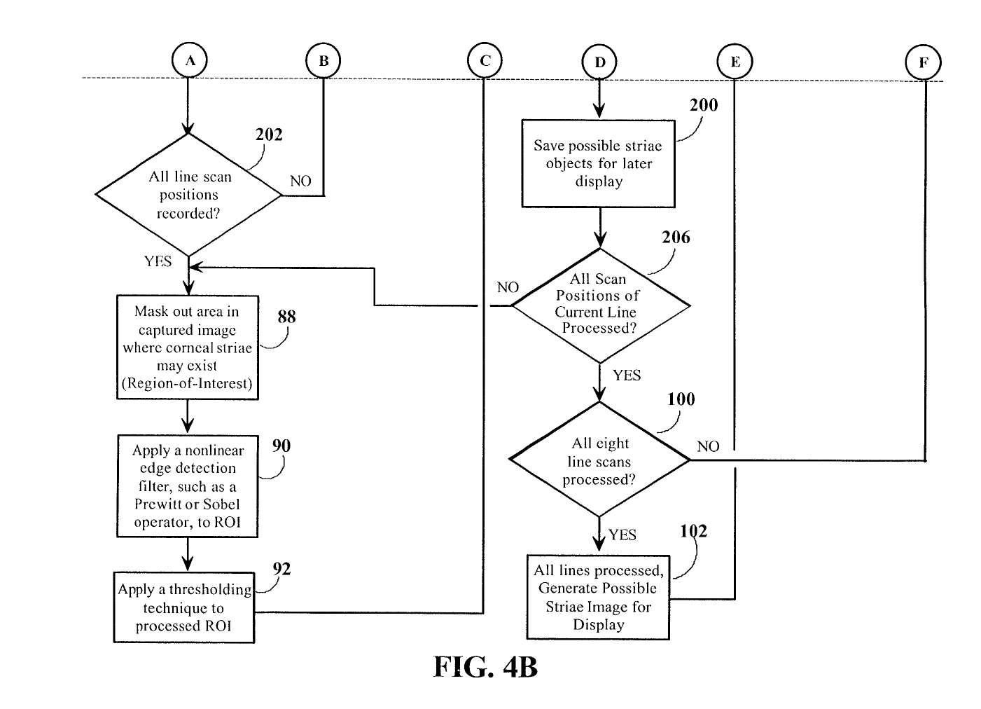

The automated eye corneal striae detection computer system 46, e.g., a Compaq Deskpro EN, 450-MHz PC, generally includes a video camera interface 50 that is coupled to the video-out port of the video camera 44 through a video camera cable 150, and a frame grabber 52, e.g., a National Instruments PCI 1411. The computer system 46 also includes a video display interface 56 that is coupled to a surgeon's video display 62 through a video display cable 152, and an opto-isolated corneal illuminator and patient positioning PC interface board 48, e.g., a National Instruments PCI-6527. In addition, the computer system 46 includes an eye corneal striae recognition processor 54, which implements a software algorithm 80 for striae detection as discussed below with respect to FIGS. 4A and 4B.

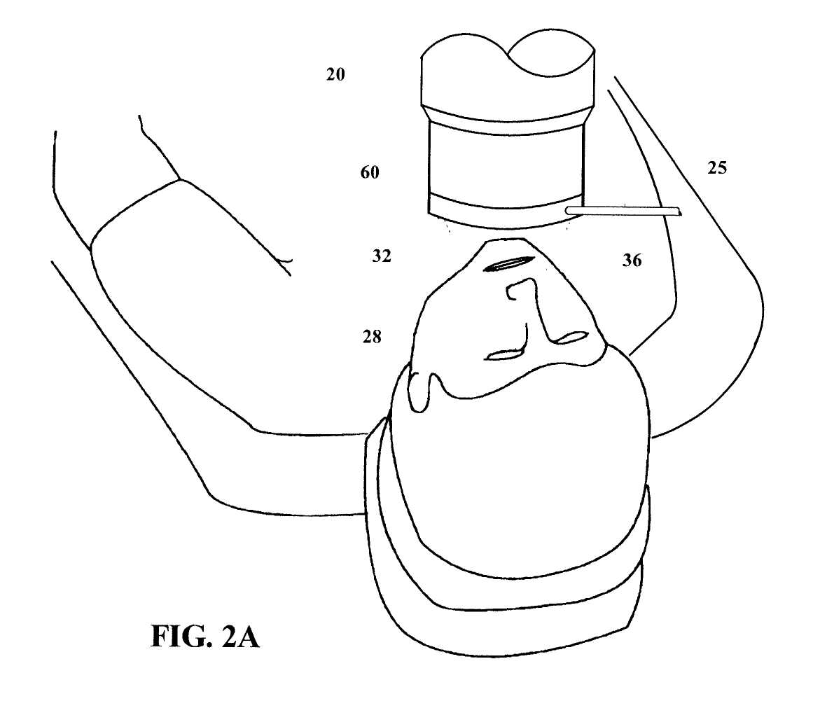

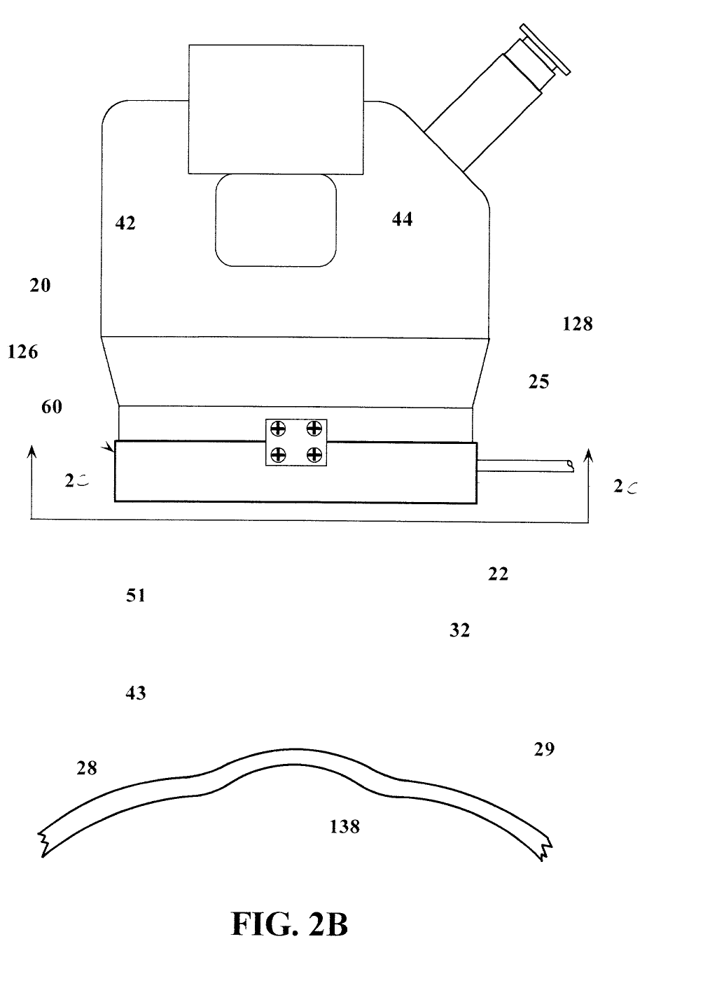

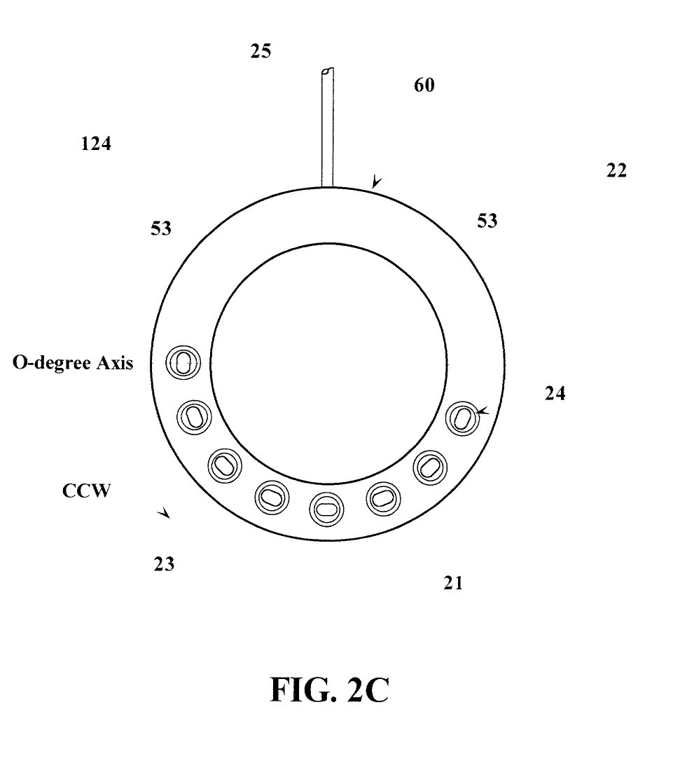

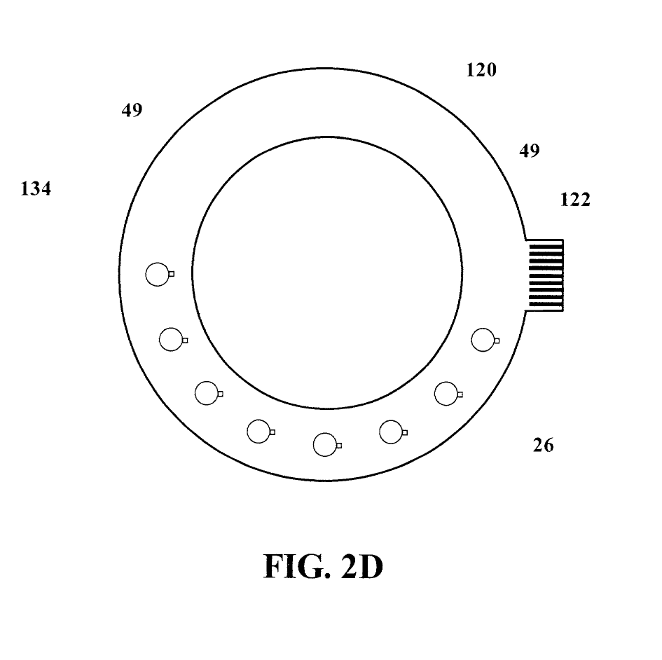

Referring to FIG. 2A, a corneal illuminator 60, attached to the refractive surgery system operating microscope 20, is shown in relationship to a patient's cornea 28. Referring to FIG. 2B, the corneal illuminator 60 includes a ring illuminator housing 22 and an illumination light source printed circuit board 120 (FIG. 2D). The ring illuminator housing 22 is constructed and arranged to be mounted on the base of the refractive surgery system operating microscope 20. A ring illuminator housing mounting bracket 128 and a set of mounting fasteners 126 are used to mount the corneal illuminator 60 to the refractive surgery system operating microscope 20, although other mounting methods may be used.

Ring illuminator housing 22 is in the form of a preferably continuous ring having an inner diameter generally sufficient to ensure an adequate clearance space 124 so as not to interfere with the delivered laser beam or the optical view of the surgeon (FIG. 2C). In the preferred embodiment, the diameter of the clearance space 124 is approximately 50 mm. Ring illuminator housing 22 is also provided with a plurality of annularly arranged circular openings 21 that are preferably evenly spaced (though may be otherwise spaced) around the ring illuminator housing 22. In a preferred embodiment, preferably eight circular openings are arranged as follows. Beginning on the left at the 0-degree axis, a hole exists for illumination scan line 36, the scan lines being described below in greater detail. Counterclockwise (CCW) 22.5° from 0°, the next hole exists for another illumination scan line 35. Counterclockwise (CCW) 45° from 0°, the next hole exists for another illumination scan line 34. This arrangement repeats for all eight holes that are spaced at 22.5° intervals.

Referring to FIGS. 2C and 2D, the illumination light source printed circuit board 120 includes illumination light sources 24 coupled to line generator optics 23. The light sources are preferably white light emitters 26, although any preferably monochromatic light source wavelength that is reflected by the cornea is applicable, which may be fiber bundles, light emitting diodes, incandescent bulbs, halogen bulbs, etc. The line generator optics 23 may be cylindrical lenses, micro rod lenses, Powell-glass lenses, etc. In the preferred embodiment, eight bright white light emitting diodes, e.g., Lumex SSL-LX3054UWC/A, serve as the light emitters 26, and when coupled to the line generator optic 23, e.g., an Edmund Industrial Optics L54-088, serve as the illumination light sources 24. When spaced evenly around ring illuminator housing 22, as shown in FIG. 2D, illumination light sources 24 provide scan lines 32, 33, 34, 35, 36, 39, 45 and 47, which pass through the circular openings 21 to illuminate the cornea 28. The scan lines are preferably directed through the openings 21 to the cornea at an angle of 16° from the optical axis 138, although other angles may be implemented. A greater or fewer number of illumination light sources 24 may be employed. In addition, the printed circuit board has a large clearance hole 134 preferably coaxial with clearance space 124 so as not to interfere with the delivered laser beam or the optical view of the surgeon.

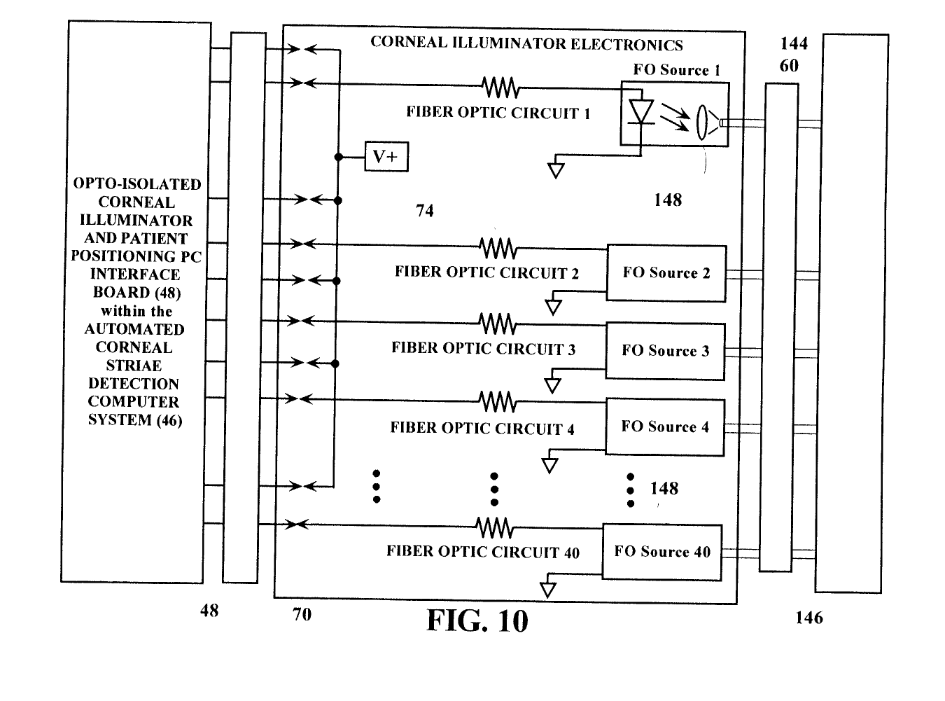

A corneal illuminator interface cable 25 connects to the illumination light source printed circuit board 120 at an illuminator interface connector port 122, shown as an edge card connector arrangement although other connector arrangements may be used, and to a corneal illuminator electronics and patient positioning interface subsystem 58. Alternatively, the light emitters 26 may be individually wired to the corneal illuminator interface cable 25 that connects to the corneal illuminator electronics and patient positioning interface subsystem 58. Even further, light emitters 26 may be individual fiber optic cables connected to an alternative fiber optic corneal illuminator electronics and patient positioning interface subsystem 144 through a fiber optic corneal illuminator interface bundle 146, as described below with respect to FIG. 10.

A patient positioning system, such as a surgical chair 57 (or bed or headrest) provided with motors, is capable of relatively rapidly positioning the chair such that an eye of a patient in this chair is moved relative to illumination scan lines 32, 33, 34, 35, 36, 39, 45 and 47 to thereby scan the lines across the cornea.

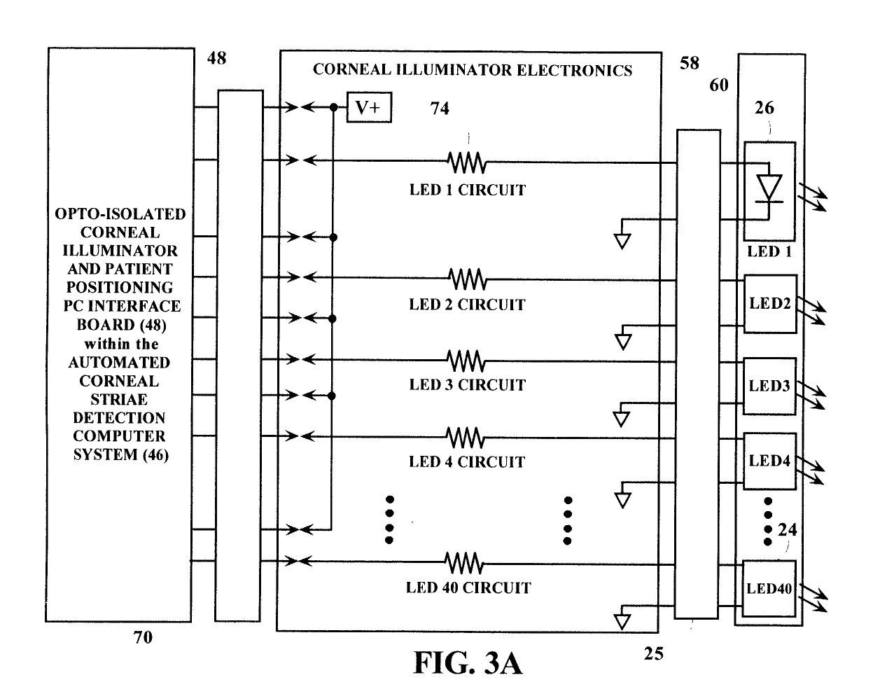

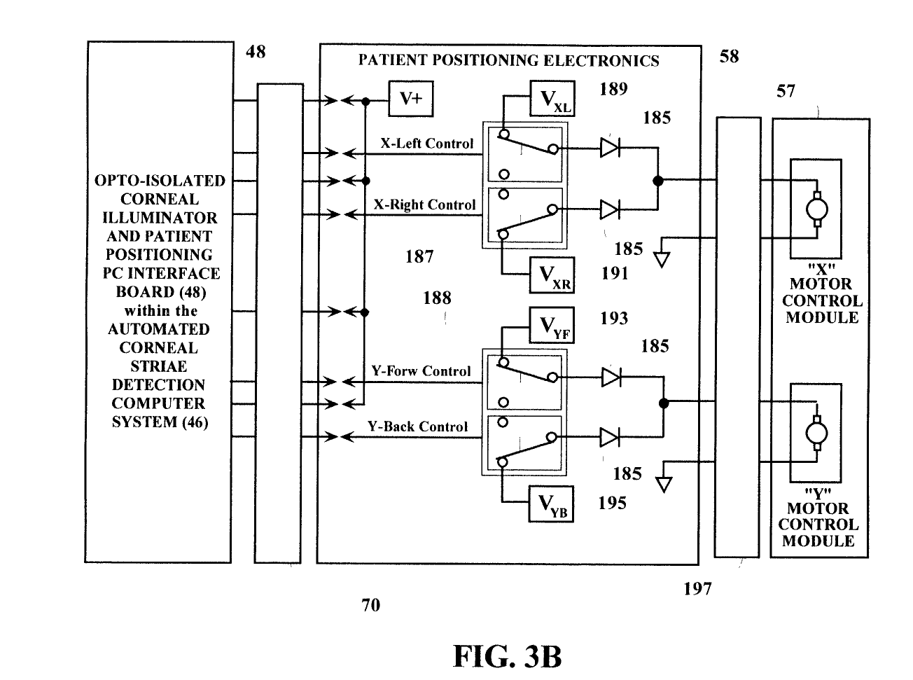

Referring to FIG. 3, the corneal illuminator electronics and patient positioning interface subsystem 58 is connected by corneal illuminator interface cable 25 to the corneal illuminator 60 and by an interface cable 70 to the opto-isolated corneal illuminator PC interface board 48. The corneal illuminator electronics and patient positioning interface subsystem 58 also provides appropriate control signals to move the surgical chair 57 through a surgical bed interface cable 197. To that effect, control signals from the opto-isolated corneal illuminator PC interface board 48 are coupled to double-pole, double-throw (DPDT) relays 187 and 188, e.g., Aromat Corp. TQ2-5V relays. When activated, DPDT relays 187 and 188 couple appropriate control voltages V_{XL}, V_{XR}, V_{YF}, or V_{YB}, to surgical chair 57 “X” and “Y” motor control circuitry through surgical chair interface cable 197. DPDT relays 187 and 188 operate in such a way as to couple only one voltage (V_{XL} or V_{XR}) to the “X” motor control circuitry and only one voltage (V_{YF} or V_{YB}) to the “Y” motor control circuitry. Steering diodes 185 protect voltage supply for X-left motion, V_{XL} 189, voltage supply for X-right motion, V_{XR} 191, voltage supply for Y-forward motion, V_{YF} 193, and voltage supply for Y-back motion, V_{YB} 195 from errant feedback voltages.

Referring to FIG. 5, eight illumination scan lines 32, 33, 34, 35, 36, 39, 45 and 47 are shown in a static centered position (e.g., not being scanned) on the cornea. The scan lines are preferably each one millimeter wide and arranged at 22.5° intervals about a center and clockwise relative to a 0° axis; i.e., at 0°, 22.5°, 45°, 67.5°, 90°, 112.5°, 135°, and 157.5°. The lines are positioned on a corneal surface within a region-of-interest (ROI) 136 slightly larger than the largest LASIK incision. In a preferred embodiment, the region-of-interest (ROI) 136 is approximately 12-mm in diameter and is centered on a pupil 41, although other ROI sizes can be used. Eye 29, an iris 31 and pupil 41 are shown in relationship to the illumination light sources' coverage areas. As the scan lines are preferably one millimeter wide, the scan lines are scanned across the cornea at one millimeter intervals, using the patient positioning system, such that a scan line is subsequently positioned with an inner edge of the scan line at the location of the outer edge of the scan line in the previous position.

The apparatus of the invention is placed into operation after the LASIK surgery procedure is completed and the flap has been manipulated back to its original place by the surgeon and allowed to seal. According to FIG. 4A, in accord with the preferred algorithm 80, the automated eye corneal striae detection computer system 46 turns on appropriate LEDs at 82 by sending out a control signal at 84 through the opto-isolated corneal illuminator and patient positioning PC interface board 48 to the corneal illuminator electronics and patient positioning interface subsystem 58. The cornea 28 is thereby illuminated with a first illumination scan line 32 (FIG. 5).

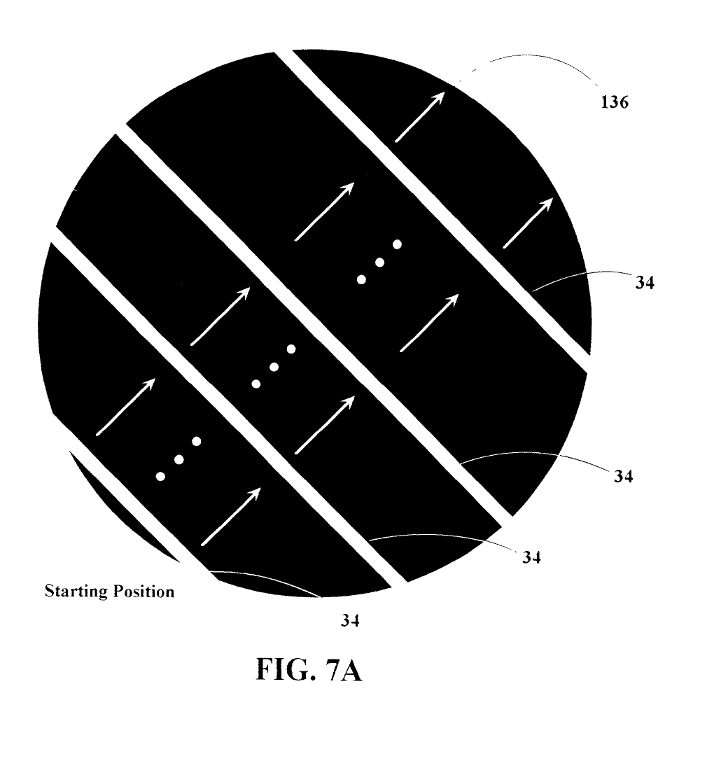

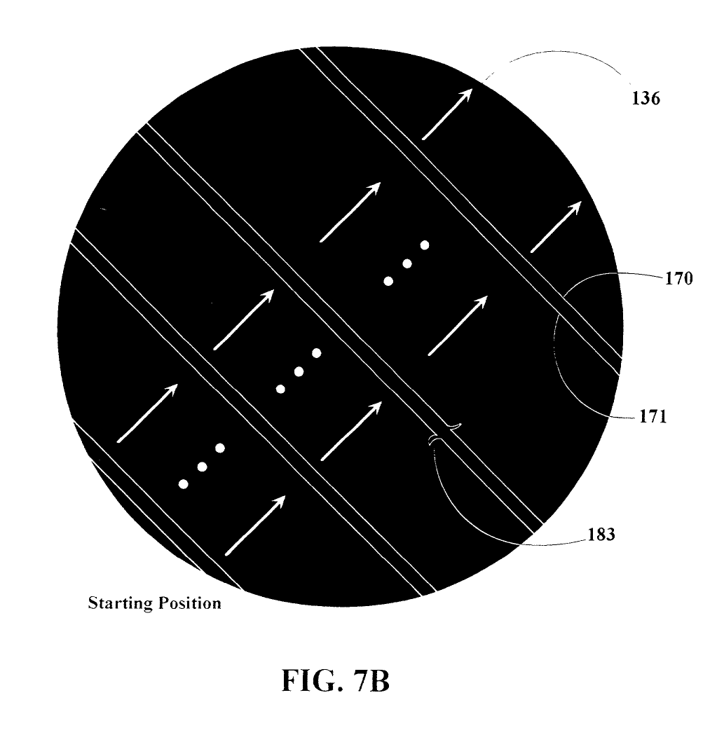

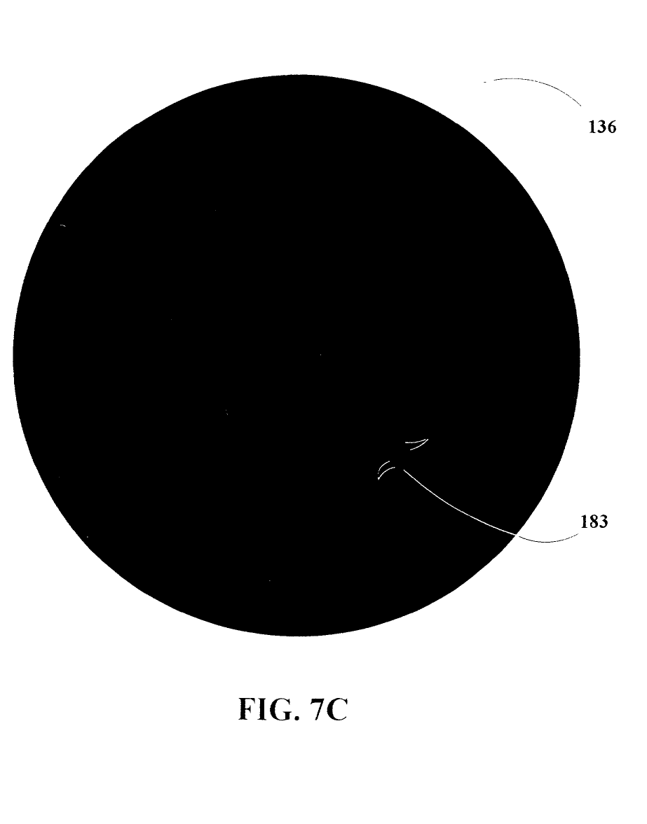

Next, at 199, the computer system 46 sends out a control signal at 84 through opto-isolated corneal illuminator and patient positioning PC interface board 48 to corneal illuminator electronics and patient positioning interface subsystem 58 to position surgical chair 57 to orient illumination scan line 32 in the correct position. For example, the beginning position of illumination scan line 32 is achieved by energizing DPDT relay 188 such that voltage supply for Y-forward motion, V_{YF} 193 is applied to surgical chair 57 until the correct position is obtained. In another example, illumination scan line 34 is placed in its original position (FIG. 7A, lower left position) by energizing DPDT relays 187 and 188 simultaneously such that voltage supply for Y-forward motion, V_{YF} 193 and voltage supply for X-right motion, V_{XR} 191 are applied to surgical chair 57 until the correct position is obtained. Once the current illumination scan line is in position, control is passed to 86.

Referring back to FIG. 1, the video camera optical port 42 to which video camera 44 is coupled is typically a microscope beam splitter optical port which permits users to attach cameras thereto for recording the surgery and audience viewing of the surgery. The automated eye corneal striae detection computer system 46 takes advantage of one of these microscope beam splitter optical ports in order to monitor the eye via a provided video camera. For example, in the VISX™ laser system, an electronic output signal port connector is provided which is attached to an internal color CCD camera. On other systems an electronic signal splitter can be attached at the output of the camera so that the video camera interface 50 and the frame grabber 52 may capture the signal. Alternatively, a separate camera may be provided with the automated eye corneal striae detection system of the invention and added to the microscope beam splitter optical port in order to capture the illuminated corneal images. That is, a number of methods and systems may be utilized to capture the image of the eye from the refractive surgery system operating microscope 20 used in performing the refractive laser surgery. The frame grabber 52 takes the signal from the video camera interface 50 and converts it to a digital signal. Alternatively, a digital camera and associated digital frame grabber, e.g., a Pulnix TMC-l000 and National Instruments PCI-1424, respectively, can be used to capture the corneal image directly in digital format.

Referring back to FIG. 4A, the automated eye corneal striae detection computer system 46 receives the digitized image signal for each scan position at 86 and converts the digitized image signal to a digital matrix, which is save (stored in memory) for individual later processing. Referring to FIG. 4B, a decision is made at 202 as to whether all of the current illumination scan line positions for a particular scan line have been recorded. If not, control is returned to 199 where surgical chair 57 is moved to the next position. For example, the second position of illumination scan line 32 is achieved by energizing DPDT relay 188 such that voltage supply for Y-back motion, V_{YB} 195 is applied to surgical chair 57 until the correct position is obtained. In the second example, illumination scan line 34 is placed in its next position (FIG. 7A) by energizing DPDT relays 187 and 188 simultaneously such that voltage supply for Y-back motion, V_{YB} 195 and voltage supply for X-left motion, V_{XL} 189 are applied to surgical chair 57 until the correct position is obtained. If all current illumination scan line positions have been recorded, control is sent to 88.

Generally, the automated eye corneal striae detection computer system 46 (1) processes the digitized corneal image for eye corneal striae recognition, (2) determines a position and a shape characteristic profile for each detected eye corneal striae object, and (3) displays the detected eye corneal striae object to surgeon's video display 62. Each of the functions of the automated eye corneal striae detection computer system 46 are preferably performed by the algorithm 80, which is now described in detail.

Once all of the current illumination scan line positions have been recorded at 86, there are several image processing methods that can be used to find eye corneal striae. One preferred method implemented by the eye corneal striae recognition processor 54 uses the contrast between the reflected illumination scan lines of light and the non-reflected surface of cornea 28. Each captured, digitized illumination scan line of light is compared against a calculated, digitized line object (or ideal line objects) to detect the striae, which distorts the reflected illumination scan line of light where present, and determines the striae's position and shape characteristic profile, preferably by the following ten steps.

First, a small area of the captured image is masked out at 88 so as to limit the region-of-interest (ROI) 136 (FIG. 5) for detecting the eye corneal striae. This region of interest is slightly larger than the LASIK incision, and in the present embodiment consists of a 12 mm diameter circular area centered on the pupil 41.

Second, image data from the region-of-interest (ROI) 136 is then processed at 90 by an edge detection operator, preferably a Prewitt or Sobel, although other edge detection approaches can be used, to highlight edges within the ROI image. Once this operation has been performed, a bimodal image is produced.

Third, a threshold function is preferably applied to the bimodal image at 92 to create a binary representation of the image, which permits faster image processing. The threshold function replaces the image intensity values below some threshold value to black (a value of zero) while placing the intensity values above the threshold value to all white (a value of 256 in an 8-bit image representation); i.e., a binary representation of the image is created. At this step the edges of the captured, digitized illumination scan lines within the ROI image are now totally white against a black background.

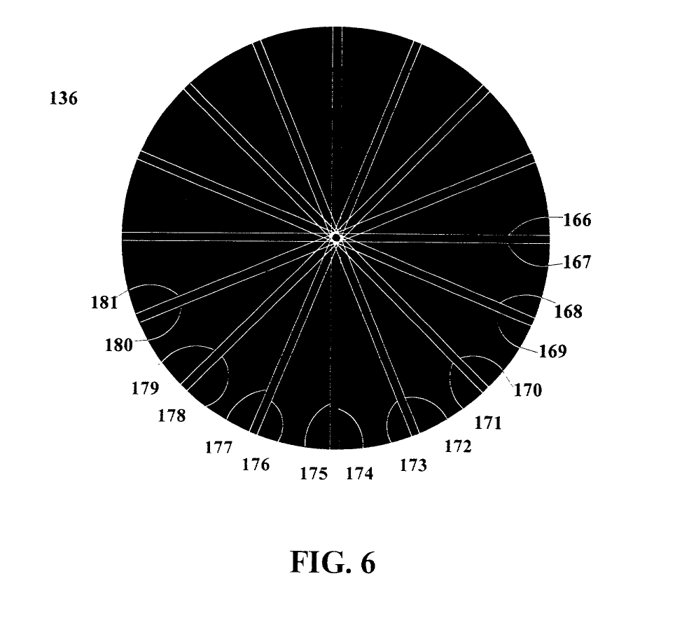

Fourth, the binary representation is preferably further processed at 94 by an outer gradient operator. In this operation an external edge algorithm subtracts the source ROI image from a dilated image of the source ROI image. The remaining image pixels correspond to the pixels added by the dilation. This yields a more pronounced image of the inner edge 167 and outer edge 166 of the captured, digitized illumination scan line 32 (FIGS. 5 and 6). The inner and outer edges 168-181 of the other scan lines (scan lines two through eight 33, 34, 35, 36, 39, 45 and 47) may similarly be detected.

Fifth, at 96, the processed binary ROI image undergoes a characterization process, termed a particle filter, to determine a set of parametric values from the image. Since all captured, digitized current positions of illumination scan line 32 will be linear (or nearly linear), processed inner edge 167 and outer edge 166 will be linear (or nearly linear) in shape and within a known length (greater than 2 mm and less than 12 mm, in the preferred embodiment). Thus, the search of the binary objects can be limited to a range defined by the dimensions and shape characteristics of illumination scan line 32. A search is then performed on the binary image for objects matching the criterion. Those objects found in this range are returned with several pieces of shape characteristic information, termed a shape characteristic profile.

Sixth, at 98, the shape characteristic information (particle parameters) is extracted from the particle filter and saved for future processing. Such pieces of shape information include, but are not limited to, object position, center of mass, bounding box coordinates, perimeter length, etc.

Seventh, referring to FIG. 4B, at 99, the shape information found at 98, in particular the bounding box coordinates and the object position coordinates, is used to create ideal line objects with lengths and positions based on processed outer and inner edges 167, 166 of scan line 32. The created ideal line objects are then subtracted from the processed inner edge 167 and outer edge 166, yielding possible striae objects. An example of one possible striae object is shown in FIGS. 7B and 7C as object 183. Any possible striae objects are saved at 200 for later display at 104.

Eighth, the algorithm 80 decides at 100 whether all illumination scan lines have been processed for each position. This is based on whether all illumination scan lines are projected individually as disclosed in the preferred embodiment; projected at the same time (as suggested by FIG. 5); or projected in any other combination. In the preferred embodiment, scan lines at each position are individually recorded at 202, and then for each position processed at 88, 90, 92, 94, 96, 98 and 99. If all illumination scan lines have been processed at 206 (scans for each individual line) and then at 100 (all lines), the algorithm then continues on to display the results at 102 discussed below. If not, the algorithm continues at 82 (FIG. 4A) where the next illumination scan line is illuminated on the cornea. Algorithm control then continues as previously described.

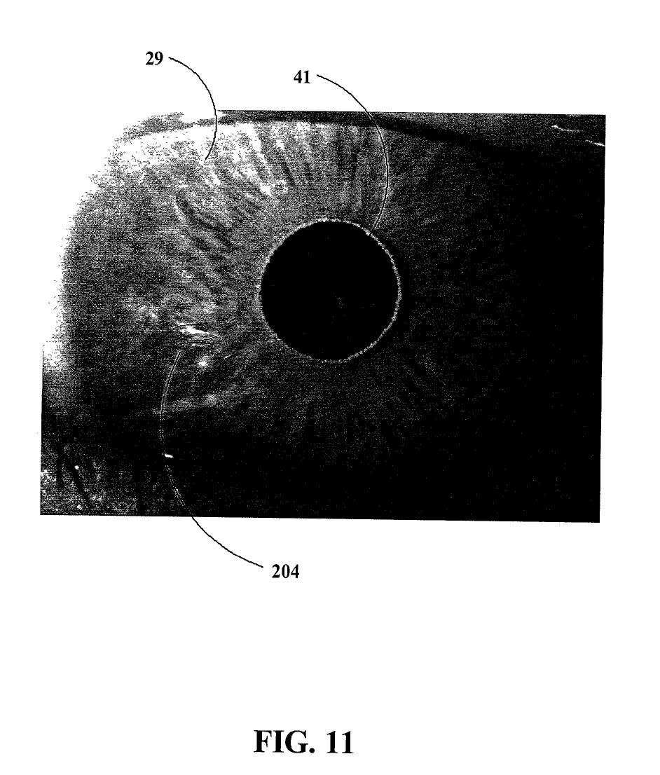

Ninth, at 102 (FIG. 4B), possible striae found at 99 are highlighted with a high-contrast color, such as red, yellow or green, although other high-contrast colors would suffice, and integrated with a digitally captured image of the eye 29 so that the possible corneal striae are obvious to the surgeon. This new generated image (FIG. 11) is sent at 104 to the surgeon's video display 62 for viewing by the surgeon or other medical practitioner, with the possible corneal striae 204 highlighted. (It is noted that the striae 204 displayed in FIG. 11 do not correspond in location to the possible striae identified in FIGS. 7B and 7C.)

Tenth, at 106, the surgeon is given the option to repeat the process. This may occur after the surgeon has smoothed a striae or wrinkle, or when the surgery procedure is complete. If the surgeon requires another process, algorithm control is sent back to 82 and the procedure repeats. If the surgeon indicates the procedure is complete, the algorithm is finished at 108.

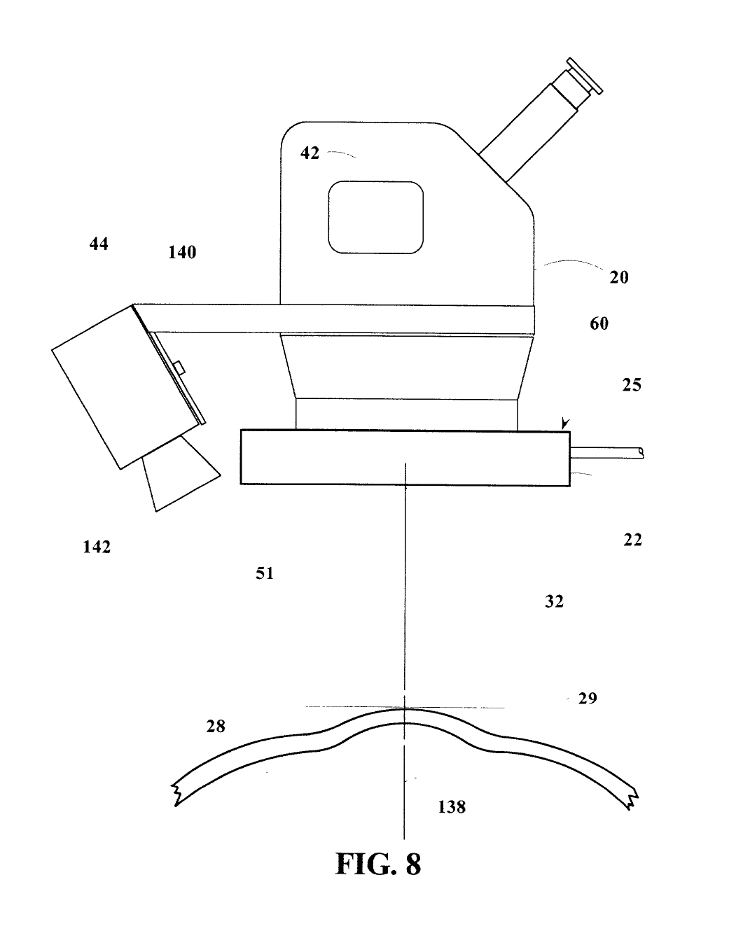

It is recognized that there may be variations on the present system and method that are within the scope of invention. By way of example, the video camera 44 may be otherwise positioned. Referring to FIG. 8, the video camera 44 is shown mounted to the refractive surgery system operating microscope 20 by a mounting bracket 140 at an appropriate angle to capture an image of the cornea and at a proper position so as not to interfere with the surgeon or surgeon's assistants. A video camera lens 142 is used to provide the automated eye corneal striae detection computer system 46 (FIG. 1) with an appropriate sized image to perform striae detection. The addition of the video camera lens 142 ensures that eye corneal striae recognition processor 54 receives a similar image as is delivered in the previous embodiment. In this embodiment the output port of the video camera 44 is connected to the video camera interface 50 in the automated eye corneal striae detection computer system 46 through the video camera cable 150 as before.

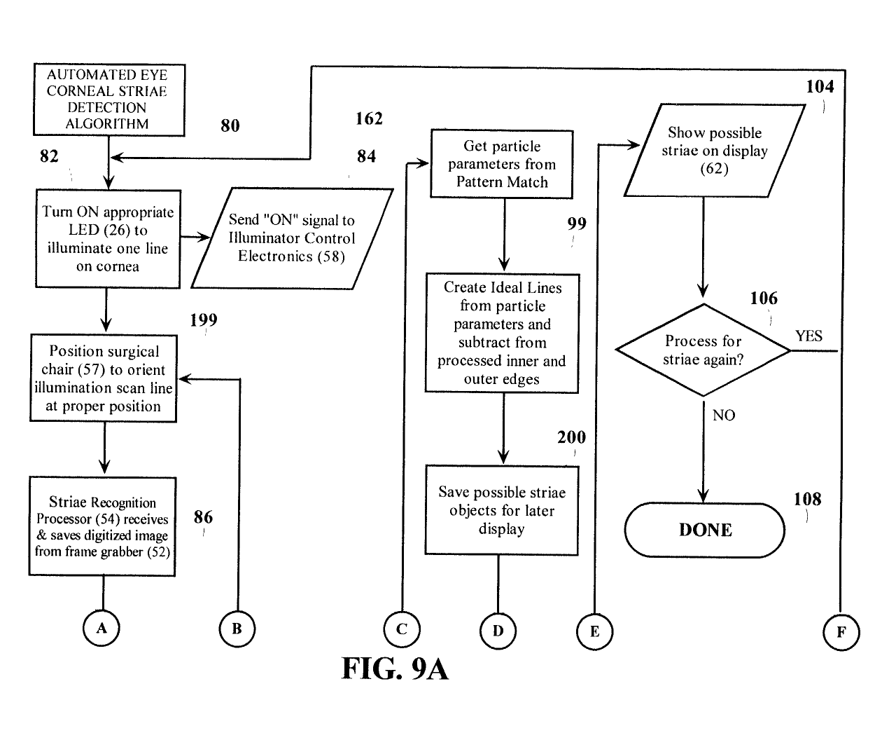

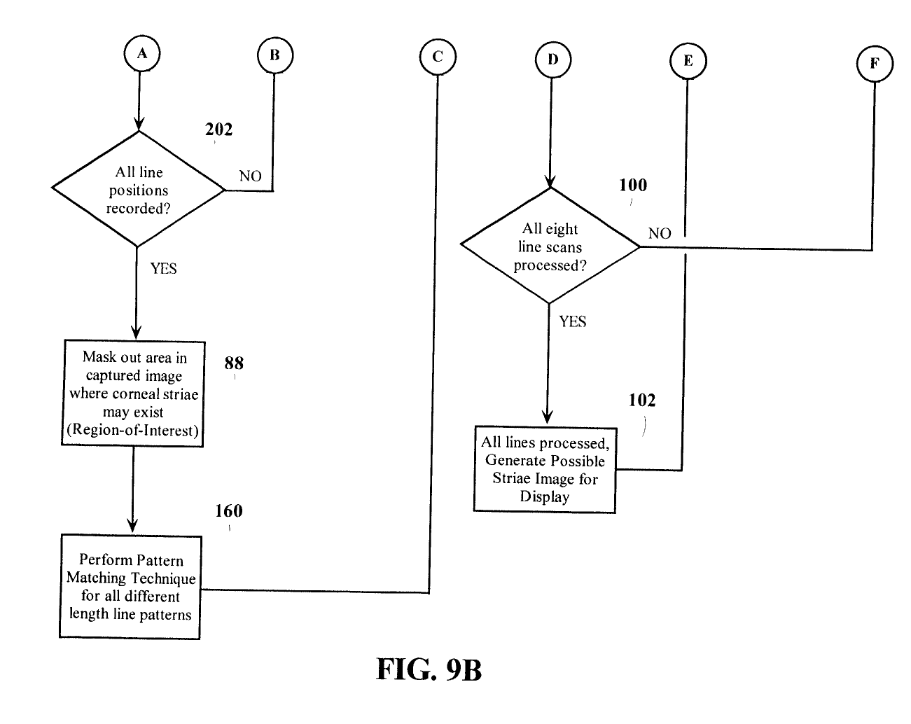

In addition, another eye corneal striae recognition approach can be used. For example, referring to FIGS. 9A and 9B, an eye corneal striae recognition technique involving pattern matching can be implemented at 160. As in the preferred embodiment, the cornea is illuminated with illumination scan line 32 at 82 and 84; surgical chair 57 moves the patient, and this the patient's eye, to the correct position and the illuminated cornea image is captured and saved for later processing at 86; a decision is made at 202 (FIG. 9B) as to whether all positions of the current illumination scan line have been captured and saved; possible corneal area (ROI) for striae is masked out at 88;, and a pattern matching technique is applied at 160. This alternative pattern matching technique uses a grayscale pattern matching method based on correlation. Known, defined illumination line objects (e.g., known lengths and widths) are scanned through each ROI image searching for a pattern match. The technique is shift-invariant, stretch or size-invariant, and rotation-invariant, and is highly immune to adverse lighting conditions, focus variations, or noise. Once an illumination line object is found, its shape characteristic information (particle parameters), such as object position, center of mass, and bounding ox coordinates, are saved at 162 as in the main embodiment algorithm, and processing then occurs as before at 99. Algorithm control continues from here as described in the main embodiment.

Turning now to FIG. 10, an alternative illumination means is shown. A fiber optic corneal illuminator electronics interface subsystem 144 includes fiber optic illumination light sources 148. The interface subsystem 144 is connected by a fiber optic corneal illuminator interface bundle 146 to the corneal illuminator 60 and by an interface cable 70 to the opto-isolated corneal illuminator and patient positioning PC interface board 48. Electrical current limiting resistors 74 couple the control signal from the opto-isolated corneal illuminator patient positioning PC interface board 48 to fiber optic illumination light sources 148, e.g., an Industrial Fiber Optics IF-E97, preferably white light sources, although any monochromatic wavelength that is reflected by the cornea will suffice. Moreover, when any color monochromatic light is used (e.g., red, blue, green, etc.), either by fiber optics, LEDs, incandescent sources, etc., the lines may be processed using color techniques in which the objects are identified based on their color.

Furthermore, rather than moving the patient relative to the corneal illuminator, the lines may be scanned across the cornea while the patient is relatively immobilized. For example, the light emitters can be motorized or scanning mirrors can be utilized to scan the illumination lines across the cornea.

From the embodiments of the invention described above it can be appreciated that the automated eye corneal striae detection system provides a very effective method for detecting eye corneal striae, or wrinkles, that may be present after LASIK refractive surgery. Since the automated eye corneal striae detection system actually detects and displays eye corneal striae, it offers several advantages over current methods aimed at only preventing striae. Additionally, the automated eye corneal striae detection system provides detection of striae from several different angles thereby offering superior corneal coverage over current manual techniques that use only two or three angles.

While the invention has been described in accordance with what is presently considered to be the preferred embodiments, it is to be understood that the invention is not limited to the disclosed embodiments, but on the contrary, is intended to cover various modifications and equivalent arrangements. Thus, while particular functional systems have been disclosed, it will be appreciated that other functional systems may be used as well. That is, the striae recognition processor and corneal illuminator electronics interface subsystem may be combined in a single system or further divided to perform the required tasks of the invention. Furthermore, while a particular preferred method and alternative methods have been disclosed for striae detection, it will be appreciated that other algorithms may be used. For example, neural network processing techniques, which are very efficient at pattern matching, can be used. Additionally, as only one video camera has been shown, it will be appreciated that two or more video cameras could be implemented to offer an increase in processing speed as well as additional information about striae object parameters, such as height information, etc. Furthermore, while a video display is preferred for display of the striae objects to the medical practitioner, it will be appreciated that other display means, e.g., high resolution printed image or a printed schematic indicating striae location, can also be used. It will therefore be appreciated by those skilled in the art that yet other modifications could be made to the provided invention without deviating from its spirit and scope as claimed.

What is claimed is:

1. An automated eye corneal striae recognition system, comprising:
a) means for projecting a plurality of illuminating scan lines of light on an eye cornea;
b) means for moving the projected illuminating scan lines and the eye cornea relative to each other;
c) means for capturing a plurality of images of the illuminated eye cornea for each scan line of light as each said scan line of light and the eye cornea are moved relative to each other; and
d) a computer system including,
(i) means for controlling said means for scanning the eye cornea,
(ii) means for receiving said images of the eye cornea from said means for capturing said plurality of said images, and
(iii) a processor means for
(A) processing said image,
(B) detecting corneal striae objects from the processed images if corneal striae are present, and
(C) determining respective positions of the detected corneal striae objects.

2. An automated eye corneal striae recognition system according to claim 1, further comprising:
e) means for indicating to a medical practitioner the respective positions of the detected corneal striae objects relative to the eye cornea.

3. An automated eye corneal striae recognition system according to claim 2, wherein:
said means for indicating is a video display.

4. An automated eye corneal striae recognition system according to claim 1, wherein:
said light is at a wavelength adapted to be reflected by the cornea.

5. An automated eye corneal striae recognition system according to claim 1, wherein:
said light is monochromatic.

6. An automated eye corneal striae recognition system according to claim 1, wherein:
said light is white light.

7. An automated eye corneal striae recognition system according to claim 1, wherein:
said means for projecting includes,
(i) a housing having a plurality of annularly arranged spaced openings adapted to direct light toward the eye cornea,
(ii) a supporting means within said housing for supporting a source of a light beam at each of said openings, and
(iii) means for controlling each said source of a light beam individually.

8. An automated eye corneal striae recognition system according to claim 7, wherein:
said source of the light beam at each of said openings includes a light emitter coupled to line generator optics.

9. An automated eye corneal striae recognition system according to claim 8, wherein:
said light emitter includes one of a fiber optic element, an incandescent bulb and a halogen bulb.

10. An automated eye corneal striae recognition system according to claim 8, wherein:
said light emitter includes a light emitting diode.

11. An automated eye corneal striae recognition system according to claim 10, wherein:
said supporting means for each said light emitting diode within said housing is a printed circuit board.

12. An automated eye corneal striae recognition system according to claim 1, wherein:
said means for projecting said plurality of illumination scan lines of light on an eye cornea projects at least one scan line of light on the cornea at a first time and at least one other scan line of light on the cornea at a second time.

13. An automated eye corneal striae recognition system according to claim 1, wherein:
said means for moving the projected illuminating scan lines and the eye cornea relative to each other moves a head of a patient relative to said means for projecting.

14. An automated eye corneal striae recognition system according to claim 1, wherein:
said means for moving the projected illuminating scan lines and the eye cornea relative to each other moves said projected illuminating scan lines relative to the eye cornea.

15. An automated eye corneal striae recognition system according to claim 1, further comprising:
e) a laser generator for performing refractive laser surgery on the eye cornea.

16. A method for automatically detecting corneal striae, said method including:
a) projecting at least one line of light onto the cornea, said light adapted to be reflected by the cornea;
b) obtaining an image of a cornea location illuminated by said at least one line of light;
c) processing said image; and
d) determining from said processed image whether one or more corneal striae objects are present.

17. A method according to claim 16, wherein:
multiple lines of light are projected onto the cornea.

18. A method according to claim 16, further comprising:
e) repeating steps (a)-(d) with additional lines of light being projected onto the cornea, each of said lines of light being oriented at a distinct angle relative to a 0° axis on the cornea.

19. A method according to claim 18, wherein:
exactly eight lines of light are projected, each being angled 22.5° relative to adjacent lines of light.

20. A method according to claim 19, wherein:
each line of light is projected at a distinct time.

21. A method according to claim 16, wherein:
said projecting includes scanning said line of light across the cornea.

22. A method according to claim 16, wherein:
said light is monochromatic.

23. A method according to claim 16, wherein:
said light is white light.

24. A method according to claim 16, wherein:
wherein said processing includes
(i) defining a limited region-of-interest in said image for detecting the corneal striae objects,
(ii) processing image data from the limited region-of-interest by shape characteristic information such that a bimodal image is produced,
(iii) applying a threshold function to said bimodal image such that a binary representation of said image is created,
(iv) searching the binary representation image for substantially linear objects within a predetermined diameter,
(v) creating ideal lines having lengths and widths based on said edge detection operator, and
(vi) subtracting said ideal lines from edges defined in said edge detection operator such that possible corneal striae objects are identified.
